(19) United States
(12) Patent Application Publication
(10) Pub. No.: US 2004/0010573 A1
(43) Pub. Date: Jan. 15, 2004

(54) Web presence for physical entities

(76) Inventors: Philippe Debaty, Mountain View, CA (US); Patrick M. Goddi, San Jose, CA (US); William Alex Vorbau, Redwood City, CA (US); Nicholas P. Lyons, Sunnyvale, CA (US)

Correspondence Address: HEWLETT-PACKARD COMPANY, Intellectual Property Administration, P.O. Box 272400, Fort collins, CO, 80527-2400, US

(21) Appl. No.: 10/192,487

(22) Filed: Jul. 10, 2002

(51) Int. Cl. G06F 15/16

(52) U.S. Cl. 709/221; 709/224

(57) ABSTRACT

A system that provides an Internet-based representation of a physical environment which reflects physical/environmental relationships among the physical entities in the physical environment. A system according to the present teaching enables the formation of relationships involving the physical entities and the performance of behaviors associated with the relationships. A system according to the present teaching also provides an interface between physical entities and a vast assortment of Internet services in a manner that takes into account the physical environment of the physical entities.

### BACKGROUND OF THE INVENTION

1. Field of Invention

The present invention pertains to the field of representing physical entities. More particularly, this invention relates to web presence for physical entities.

2. Art Background

The communication protocols of the Internet have the potential to enable communication among a vast assortment of devices. Examples of devices include computer systems and networks of computer systems, handheld devices including personal organizers and telephones, appliances, industrial machines, and remote sensors and transmitters, to name just a few examples.

The communication protocols of the Internet also have the potential to enable access to a vast assortment of services. Examples of services include web services such as e-commerce and information services as well as web portals.

It is common for devices to have physical/environmental relationships with respect to one another. For example, a set of devices may be contained in the same structure or area or may be associated with particular organizations. In addition, it is common for devices to have physical/environmental relationships with respect to other physical entities. For example, devices may be held or worn by persons or may be otherwise associated with persons or things.

Therefore, it may be desirable to provide mechanisms for interaction among Internet services and devices in a manner that takes into account the physical/environmental relationships among physical entities. Such a mechanism based on physical/environmental relationships may be used, for example, to adapt the functionality provided by devices and services to their real-world physical/environmental relationships. Unfortunately, prior mechanisms for interaction among devices and services via the Internet typically do not take into account the physical/environmental relationships among physical entities.

### SUMMARY OF THE INVENTION

A system is disclosed that provides an Internet-based representation of a physical environment which reflects physical/environmental relationships among the physical entities in the physical environment. A system according to the present teaching enables the formation of relationships involving the physical entities and the performance of behaviors associated with the relationships. A system according to the present teaching also provides an interface between physical entities and a vast assortment of Internet services in a manner that takes into account the physical environment of the physical entities.

Other features and advantages of the present invention will be apparent from the detailed description that follows.

### BRIEF DESCRIPTION OF THE DRAWINGS

The present invention is described with respect to particular exemplary embodiments thereof and reference is accordingly made to the drawings in which:

FIG. 1 shows a system according to the present techniques;

FIG. 2 illustrates Internet communications that are enabled by a web presence;

FIG. 3 illustrates elements of a web presence in one embodiment;

FIG. 4 shows a method for establishing a representation of an actual physical/environmental relationship among physical entities.

### DETAILED DESCRIPTION

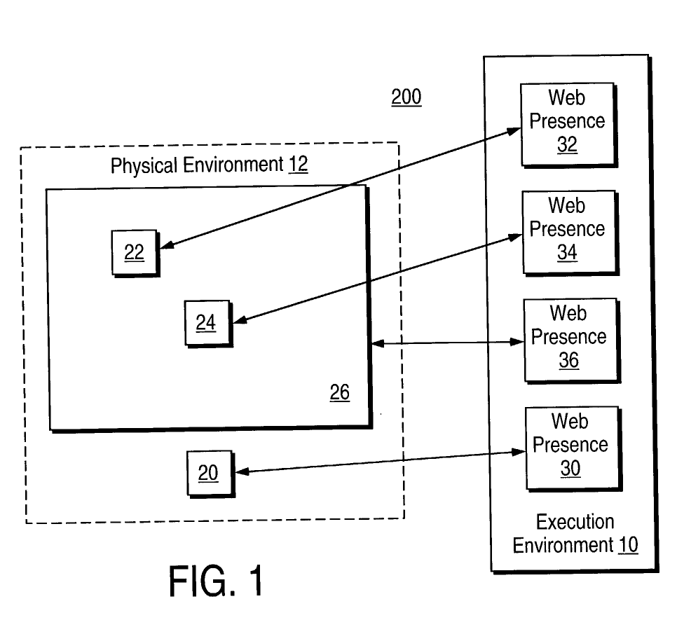

FIG. 1 shows a system 200 according to the present techniques. The system 200 includes a physical environment 12 and an execution environment 10. The physical environment 12 includes a set of physical entities 20-26. The execution environment 10 provides a representation of the physical environment 12 that reflects relationships among the physical entities 20-26 such that the representation of the physical environment 12 is accessible using Internet protocols.

Each physical entity 20-26 may be a person, a place, or a thing. The physical entities 20-26 have relationships with respect to one another in the physical environment 12. The relationships among the physical entities 20-26 may be based on physical characteristics. Examples of physical characteristics include proximity, gesture, or interaction. The relationships among the physical entities 20-26 may vary with time—for example in response to movements of one or more of the physical entities 20-26.

The execution environment 10 enables the performance of behaviors which are adapted to the physical/environmental relationships of the physical entities 20-26. The execution environment 10 enables interaction with Internet resources including information services, e-commerce/business services. The execution environment 10 also enables interaction with Internet enabled appliances.

The execution environment 10 in one embodiment includes a set of web presences 30-36. The web presence 30 corresponds to the physical entity 20, the web presence 32 corresponds to the physical entity 22, etc. Each web presence 30-36 provides a web-based representation of its corresponding physical entity 20-26.

A web-based representation reflects the environmental conditions of the corresponding physical entity including its physical/environmental relationship to other physical entities. For example, the web presence 36 may represent that the physical entities 20-22 are contained within the physical entity 26. Similarly, the web presence 32 may represent that the physical entity 22 is contained within the physical entity 26.

The web presences 30-36 respond to changes in the physical/environmental relationship of the physical entities 20-26. For example, the web presences 30-36 may respond to any movements of the physical entities 20-24 between an exterior of the physical entity 26 and an interior physical entity 26 and update their representations accordingly.

The web presences 30-36 may run on the same computer system or similar device or may be distributed among multiple computer systems or similar devices. A given web presence may run on the same computer system or similar device or may be distributed among multiple computer systems or similar devices. Communication among hardware elements that execute the web presences 30-36 may use any type of communication mechanism that supports Internet protocols.

The execution environment 10 enables an integration of the physical environment 12 with the world of web information and web services. This enables the physical entities 20-26 to interconnect using web standards. The web presences 30-36 provides a core set of capabilities to the physical environment 12 that are needed for building and/or binding to web services.

The execution environment 10 may support any number web presences. The execution environment 10 may include a data manager which is an abstraction of a set of data representations in the system 200, where the actual data may exist either inside or outside the system 200.

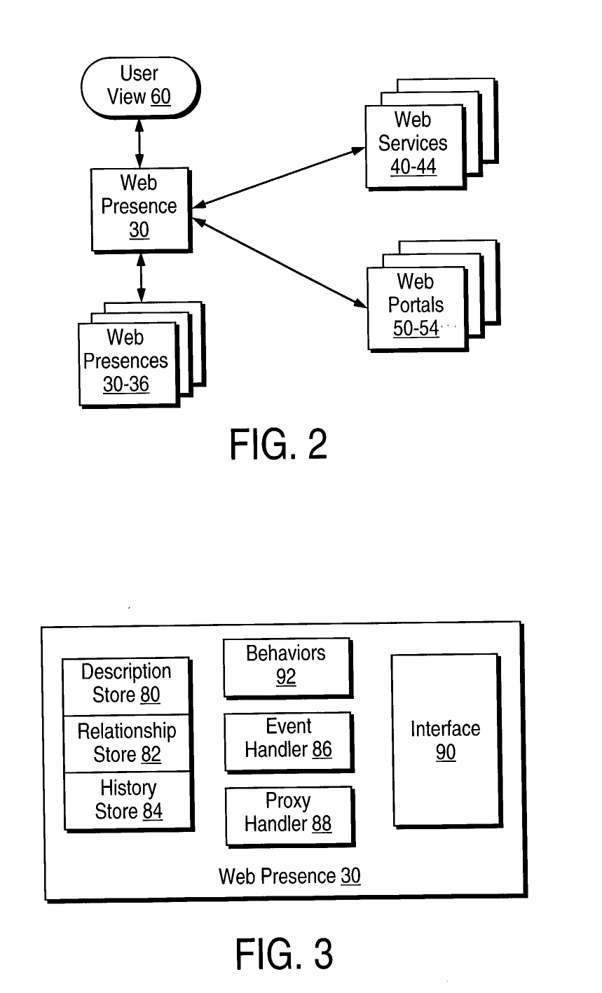

FIG. 2 illustrates Internet communications that are enabled by the web presence 30. The web presences 32-36 may provide similar functionality. The web presence 30 includes mechanisms for interaction with the web presences 32-36, a set of web services 40-44, and a set of web portals 50-54. Examples for the web services 40-44 are numerous and includes information services and e-business/commerce services. Examples for the web portals 50-54 are numerous and well known. The web services 40-44 and/or the web portals 50-54 may interact directly with physical environments.

In addition, the web presence 30 generates a user view 60 which is accessible using web protocols. The user view 60 may depict the physical/environmental relationship of the physical entity 20 with respect to the other physical entities 22-26 and may include other information which is specific to the physical entity 20. The user view 60 may be implemented as a set of web pages accessible using Internet protocols.

FIG. 3 illustrates elements of the web presence 30 in one embodiment. The web presence 30 in this embodiment includes a description store 80, a relationship store 82, a history store 84, an event handler 86, a proxy handler 88, an interface 90, and a set of behaviors 92. The web presences 32-36 may have similar arrangements.

The elements of the web presence 30 may be implemented in code that runs on the physical entity 20 or a processing device associated with the physical entity 20 or may be implemented in code that runs on some other processing devices, for example a computer system or similar device with software execution resources and web connectivity.

The description store 80 holds a set of static information pertaining to the physical entity 20. The type of static information in the description store 80 may depend on the nature of the physical entity 20. The static information may include characteristics of the physical entity 20. The static information may include state information for the physical entity 20. The state information for the physical entity 20 may include current sensor readings, and/or information regarding an internal computational state or physical configuration.

The relationship store 82 holds a log of any relationships formed between the physical entity 20 and the other physical entities 22-26. In addition, the relationship store 82 holds a log of any relationships formed between the physical entity 20 the web services 40-44 and/or the web portals 50-54. The information in the relationship store 82 may include type information and other meta data that enable the web services 40-44 to determine the environment of the physical entity 20 through its physical relationships within the physical environment 12.

The history store 84 is a log of past interactions and events associated with the physical entity 20. An example of an event associated with the physical entity 20 is its movement between the interior and the exterior of the physical entity 26. An example of an interaction associated with the physical entity 20 is an interaction with the web services 40-42, the web portals 50-54, or the web presences 32-36.

The history store 84 may also include physical and other environment information. The environment information may be captured from the physical entity 20, for example using any sensors sensor associated with the physical entity 20. The environment information may be queried from the web presences 3236 if the physical entities 22-26 are listed in the relationship store 82 as having the capability of providing sensor data.

The event handler 86 may execute one or more of the behaviors 92 in response to specific events associated with the physical environment 12 or the execution environment 10. The web presence 30 may be provided with a set of rules that specify which of the behaviors 92 are to be performed in response to which events.

The interface 90 provides access to the web presence 30 through common web-based mechanisms including support for programmatic, forms-based, and standard web page access. These interfaces are available to the other web presences 32-36, the web services 40-44, the web portals 50-54, as well as other web-based applications, and end-user browsers. The interface 90 includes a web server function for providing the user view 60 to a web client.

The proxy handler 88 bridges a native interface of the physical entity 20 to the web presence 30, thereby augmenting limitations of the physical entity 20 with web presence capabilities including web interfaces, history, additional behaviors, etc.

The proxy handler 88 may include functionality for controlling the physical entity 20. For example, if the physical entity 20 is a printer, the proxy handler 88 may provide a printing interface including the capability to submit a document for printing. In another example, if the physical entity 20 is an X10 compliant light, the proxy handler 88 may provide a proxy for controlling the on/off capability of the light controller. The proxy handler 88 may include functionality for obtaining data from any sensors related to the physical entity 20.

The web presence 30 may provide an aggregating function by controlling the other web presences 32-36 and the web services 40-44 through the interface 90. The web presence 30 having such an aggregating function may be an abstraction of the other web presences 32-36 to provide an aggregated web presence. For example a web presence for a room may provide thermostatic control, lighting control, etc., that are aggregating the web presence of these individual physical devices.

The web presence 30 may provide information and behaviors for customizing the user view 60 to a particular system that includes services of a local environment. The relationship with a local environment may be used to query all entities and services relevant in the local environment, and then these entities and services may be integrated into the user view 60, which may include global as well as local capabilities.

The relationships associated with the web presence 30 may be viewed as a typed and connected diagram of physical entities with a chain of relationships. Such a view may be used to optimally utilize resources in a physical environment. For example, if the physical entity 20 is a person inside the physical entity 26 which is a room, and that person is holding a device such as a PDA, then one of the web services 40-44 having a relationship with the web presence 36 may use the chain of relationships (room contains person, person holds PDA) to determine that it may send a form to the PDA. If the room has many other display appliances, the physical information associated with the physical entities in the room may be used by a service to select one. This physical information is obtainable through the representation provided by the web presence 36 from the information in the relationship store 82.

The behaviors 92 of the web presence 30 may be customized and extended. The behaviors 92 may be set to access available local services or appliances before they are encountered. For example, the entry of the physical entity 20, for example a person, into the physical entity 26, for example a room, may trigger a set of behaviors through the execution environment 10. These behaviors may include automatically adjusting lighting, playing music, etc. on the physical entities 22-24, which may be for example lighting and music appliances, that offer these capabilities via their web presences 32-34. These behaviors may be involve connections to the web services 40-44 as well—for example automatically streaming music from a music service.

One of the web presences 30-36 may maintain a history of physical interactions and associated information for management and maintenance purposes in the execution environment 10.

The physical entities 20-26 may include persons, places, and/or things. Examples of places are numerous and include geographic regions, political regions, organizational region, contractual region, etc. Examples of things include devices and structures. Examples of structures including buildings and vehicles. Examples of devices include computers, peripheral devices, appliances, displays, entertainment and information devices and others too numerous to mention.

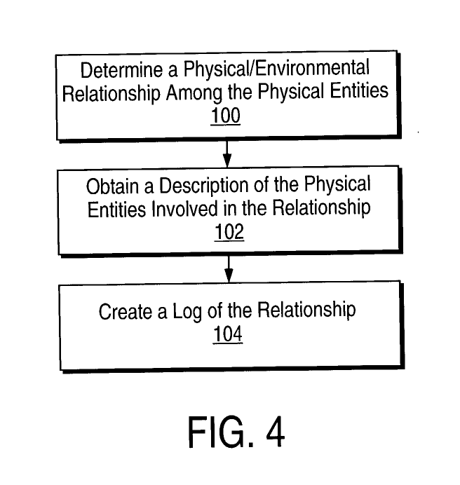

FIG. 4 shows a method for establishing a representation of an actual physical/environmental relationship among the physical entities 20-26. In the following example, the physical entity 20 is a person, the physical entity 26 is a room which contains the physical entities 22-24 which are a printer and a display, respectively.

At step 100, a physical/environmental relationship among the physical entities 20-26 is determined. A physical/environmental relationship may be determined in any manner. In this example, a movement of the physical entity 20 from an exterior into an interior of the physical entity 26 is detected at step 100.

In one embodiment, the physical entity 26 includes a transmitter, for example an infrared transmitter, that broadcasts an identifier for the physical entity 26 within its interior. The identifier for the physical entity 26 may be its URL (room URL). The physical entity 20 has a device with a receiver that receives the room URL. The device may be a handheld computer or other device with a suitable detector. The web presence 30 obtains the room URL from the PDA or other device via the proxy handler 88.

The PDA or other device carried by the physical entity 20 may include an embedded web server function that enables the proxy handler 88 to obtain the room URL using web protocols. Alternatively, the PDA or other device carried by the physical entity 20 may use some other communication mechanism to transfer the room URL to the proxy handler 88.

At step 102, a description is obtained of the physical entities involved in the physical/environmental relationship determined at step 100. In the example embodiment, the web presence 30 obtains a description of the physical entity 26 using the room URL. The web presence 30 obtains a description of the physical entity 26 from the web presence 36. The web presence 30 may use web protocols to obtain an XML description of the physical entity 26.

The description of the physical entity 26 obtained from the web presence 36 may include information contained in the description store of the web presence 36. The description of the physical entity 26 obtained from the web presence 36 may also include information from the relationship store of the web presence 36 which indicates any relationships formed with the physical entity 26 and other physical entities and/or web portals, and/or web services. For example, the information from the relationship store of the web presence 36 may include descriptions of the physical entities 22-24 which the web presence 36 had previously obtained from the web presences 22-24 when forming those relationships.

In the example embodiment, the description of the physical entity 26 obtained from the web presence 36 identifies the room, and identifies the printer 22 and the display 24 and their characteristics along with URLs that enable web based communication with their web presences 32-34 including their proxy handlers.

At step 104, the web presence 30 creates a log in the relationship store 82 of the relationship of the physical entity 20 to the physical entity 26. The log entry into the relationship store 82 includes the description of the physical entity 26 obtained from the web presence 36. This log entry is used by the web presence 30 when providing a description, i.e. representation, of the physical entity 20 to the other web presences 32-36, the web services 40-44, and the web portals 50-54, and when constructing the user view 60.

The web presence 30 constructs the user view 60 in response to web client requests. For example, the physical entity 20, a person, may carry a PDA with web client capabilities that obtains the user view 60 from the interface 90 using web protocols and that displays to user view 60. The communication link between the hardware that executes the web presence 30 and the PDA or other device may be any type of link and may be a wireless link. In the example, the user view 60 may be a web page that provides a graphical/text view of the room and its characteristics and of the physical entities 22-24 and their characteristics along with any of the web services 40-44 and the web portals 50-54 that have relationships established with the physical entity 26.

The web presence 30 creates an event entry in the history store 84 when the movement of the physical entity 20 to the interior of the physical entity 26 is detected. The event entry specifies a movement into a new room. The event handler 86 performs any of the behaviors 92 which are registered to be executed upon a movement to a new room event.

One example of a behavior that may be performed upon movement of the physical entity 20 into a new room is notification of appropriate ones of the web services 40-44 and the web portals 50-54 of the new physical environment, i.e. a change in relationship, which now contains the physical entity 20. The specification of which web service or portal is to be notified my be registered with the behavior rule.

Another example of a behavior that may be performed upon movement of the physical entity 20 into a new room is the transfer of a web page that describes the physical entity 20 to a display in the room.

Yet another example of a behavior that may be performed upon movement of the physical entity 20 into a new room is a personalized request to one of the other physical entities in the new room. An example of a personalized request is a request to a music appliance to play a particular song.

The present techniques provide an execution environment and system for managing and delivering information about physical entities and environments using extensible open web standard approaches. Web services including commerce applications and portal applications, as well as web-based appliances may use the representation provided by the execution environment as a standard abstraction to represent physical information and environments and employ a standard method for access to information.

The present techniques enable the connection of web based information and services to physical environments that use sensors, transmitters, and computational and interface appliances that exist in or serve physical environments. These techniques enable the collection of information from physical environments and provides a standard way of mapping the representation of a physical environment to a web representation that is available to the vast number of web services available on the Internet. Conversely, these techniques provide a mechanism for mapping information and media available on the web to physical entities in a physical environment.

The foregoing detailed description of the present invention is provided for the purposes of illustration and is not intended to be exhaustive or to limit the invention to the precise embodiment disclosed. Accordingly, the scope of the present invention is defined by the appended claims.

What is claimed is:

1. A system, comprising:
physical environment having a set of physical entities;
execution environment that provides a representation of the physical environment that reflects a relationship among the physical entities such that the representation is accessible using Internet protocols.

2. The system of claim 1, wherein the execution environment includes a web presence which logs a description of the relationship.

3. The system of claim 2, wherein the web presence logs the description in response to a change in the relationship.

4. The system of claim 2, wherein the web presence obtains information for formulating the description from another web presence which corresponds to another one of the physical entities involved in the relationship.

5. The system of claim 2, wherein the web presence logs an event associated with the relationship in a history store.

6. The system of claim 2, wherein the web presence performs a behavior corresponding to the event.

7. The system of claim 2, wherein the web presence enables communication of the description to an additional web presence in the system.

8. The system of claim 7, wherein the additional web presence formulates another relationship among the physical entities in response to the description.

9. The system of claim 2, wherein the web presence enables communication of the description to a web portal.

10. The system of claim 2, wherein the web presence enables communication of the description to a web service.

11. The system of claim 2, wherein the web presence enables communication of the description to a client user.

12. A method for representing a set of physical entities, comprising the steps of:
determining a relationship among the physical entities within a physical environment;
obtaining a description of the physical entities involved in the relationship;
providing access to the description using Internet protocols.

13. The method of claim 12, further comprising the step of communicating the description to a client user.

14. The method of claim 12, further comprising the step of communicating the description to a web portal.

15. The method of claim 12, further comprising the step of communicating the description to a web service.

16. The method of claim 12, wherein the step of providing access to the description includes the step of creating a log of the description such that the log is accessible using Internet protocols.

17. The method of claim 12, further comprising the steps of:
determining an event associated with the relationship;
performing a behavior associated with the event.

18. The method of claim 17, wherein the step of determining an event comprises the step of determining a change in the relationship.

19. The method of claim 18, wherein the step of performing a behavior comprises the step of communicating the change to a web portal.

20. The method of claim 18, wherein the step of performing a behavior comprises the step of communicating the change to a web service.

21. The method of claim 18, wherein the step of performing a behavior comprises the step of communicating the change to a client user.
